(19) United States
(12) Patent Application Publication
(10) Pub. No.: US 2006/0249035 A1
(43) Pub. Date: Nov. 9, 2006

(54) Structure of mocha coffee maker

(76) Inventor: Wen-Feng Lin, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/123,038

(22) Filed: May 6, 2005

(51) Int. Cl. A47J 43/14

(52) U.S. Cl. 99/495

(57) ABSTRACT

A mocha coffee maker is composed of a lower pot, a funnel, a rubber ring, a filter and an upper pot. The filter and the rubber ring are assembled to the bottom of the upper pot, which is provided with interior threads, while the top end of the lower pot is provided with exterior threads, such that after placing the funnel on the lower pot, the upper pot will be fastened to the lower pot via threads. The funnel has a basin of an appropriate height. The basin has a hole at the central bottom. An expanded flange is provided at the outer rim of the basin, while a siphon extends from the bottom hole of the basin for releasing steamer. When the upper pot and the lower pot are screwed together, the outer film of the coffee pack/tea bag will be pressed thereby to easy coffee/tea making.

### BACKGROUND OF THE INVENTION

(a) Field of the Invention

The present invention relates to an improved structure of a mocha coffee maker, particularly to one that is adapted to brewing a coffee pack or tea bag, thereby enhancing the convenience of coffee/tea making.

(b) Description of the Prior Art

People used to brew grinded coffee or simply pour hot water into a pack of three-in-one coffee. As for those rather fastidious about coffee quality, they always brew grinded coffee by themselves. Mocha coffee makers therefore have become popular household utensils to the French, and are being used as commonly as siphon coffee makers habitually used by the Japanese. Yet, Italian roasted coffee accompanied with mocha coffee makers would accomplish coffee of the best.

In conventional mocha coffee makers as shown in FIGS. 6 and 7, the funnel 60 for the pot body includes a basin which is provided with a flange 61 at the outer rim and a siphon 62 at the bottom. A steam outlet 63 is connected onto the siphon 62. A sieve 65 with a mezzanine design is provided above the under board 64 which is in form of a flat board. The sieve 65 has pluralities of meshes 66. While the height c of the basin of the funnel 60 is a relatively bigger size, when the user intends to brew coffee, he/she must ladle an appropriate amount of coffee power (not shown) to fill up the funnel 60 and slightly excess the opening of the pot, and then tap the funnel 60 to make the coffee power tightened, rendering the coffee power dropped down. The user would further ladle some coffee power into the funnel 60 and spread the coffee power with fingers. When the water 80 is poured into the lower pot 10 (the water level should not excess the pressure relief valve), the funnel 60 is disposed into the lower pot 10, the upper pot 50 is screwed to the lower pot 10, and put the coffee maker on fire for brewing. After 1.5 to 2 minutes, the water in the coffee maker would start boiling and the steam would spurt up through the siphon 62 and escape from the meshes 66 of the sieve 65. Meanwhile, the condensed coffee liquid would be drawn into the upper pot 50 along the conduit 54 provided inside the upper pot 50. Finally, the user can hold the handle of the pot and pour out the coffee.

In view of the complicated process for brewing coffee with the conventional coffee makers, there exists a need for simplifying the steps of brewing coffee to the modern consumers who are busy and thus require time efficiency. Accordingly, a small size of coffee pack 70 (as shown in FIG. 8) has been promoted in the market. Said coffee pack 70 contains coffee of a single flavor, and is easily carried for traveling purpose. Besides, the coffee pack 70 is vacuum packaged for avoiding it from being spoiled by moist. The most of all, the coffee pack 70 is compact in weight. Since it contains coffee of a single flavor, the user can bring with him/her coffee packs of various flavors. While the coffee pack 70 contains coffee power of specific flavor, which is covered by cotton paper or non-woven fabric, and is provided with a complex outer film 702.

However, conventional mocha coffee makers are not designed for brewing such a coffee pack 70. As illustrated in FIG. 7, when the coffee pack 70 is disposed in the funnel 60, the outer film 702 of the coffee pack 70 cannot be engaged by the upper and lower pots due to the oversized height c of the basin of the funnel 60. Besides, as the meshes 66 are distributed on the funnel 60, the steam drawn from the lower pot 10 would escape up along the path that has less resistance, i.e. the periphery of the coffee pack and the interior slot of the funnel 60. As such, the steam will be drawn to the upper pot 50 through the conduit 54 provided inside the upper pot 50 at last. Accordingly, it cannot accomplish the purpose of easily brewing coffee pack to obtain condensed coffee.

### SUMMARY OF THE INVENTION

The primary object of the invention is to utilize a convenient coffee pack for brewing coffee, such that coffee making would become much easier.

The secondary object of the invention is to utilize a tea bag for making tea beverage, such that tea making would become much more convenient.

Yet a further object of the invention is utilize the novel mocha coffee make to brew coffee, such that the households can purchase various flavors of coffee packs, instead of pounds of coffee powder/bean. As coffee is not easily preserved, it can be spoiled due to humidity, rendering discard and waste, the invention can solve the disadvantage and accomplish an economic effect.

To obtain the above objects, the invention provides an improved structure of a mocha coffee maker, which is composed of a lower pot, a funnel, a rubber ring, a filter and an upper pot. The filter and the rubber ring are assembled to the bottom of the upper pot, which is provided with interior threads, while the top of the lower pot is provided with exterior threads, such that after placing the funnel on the lower pot, the upper pot will be fastened to the lower pot via threads. The funnel has a basin, which includes a circular inside wall and a top surface, at least a hole under the bottom, an interior diameter that conforms to the size of a standard coffee pack or tea bag, an expanded flange at the outer rim of the basin, and a siphon extending from the bottom hole of the basin for releasing steamer. When the upper pot and the lower pot are screwed together, the outer film of the coffee pack/tea bag will be pressed thereby. Accordingly, a mocha coffee maker for brewing coffee pack has been accomplished.

To completely appreciate these and other objects of the present invention as well as the invention itself, all of which will become apparent to those skilled in the art, the following detailed description of the invention and the claims should be read in conjunction with the accompanying drawings.

### BRIEF DESCRIPTION OF THE DRAWINGS

FIG. 1 is an exploded view of the present invention.

FIG. 2 is a perspective view of the funnel of the present invention.

FIG. 3 is an embodiment of the invention, showing application of the funnel to brew a coffee pack.

FIG. 4 is a perspective view of a funnel according to another embodiment of the invention.

FIG. 5 is an embodiment of the invention, showing application of the funnel to brew a tea bag.

FIG. 6 is a cut-away view of a funnel of a conventional mocha coffee maker.

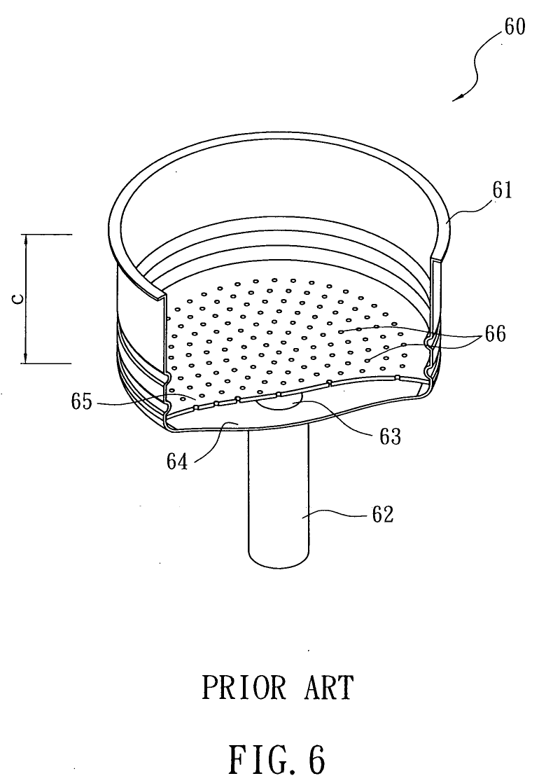

FIG. 7 shows application of a funnel of a conventional mocha coffee make to brew a coffee pack.

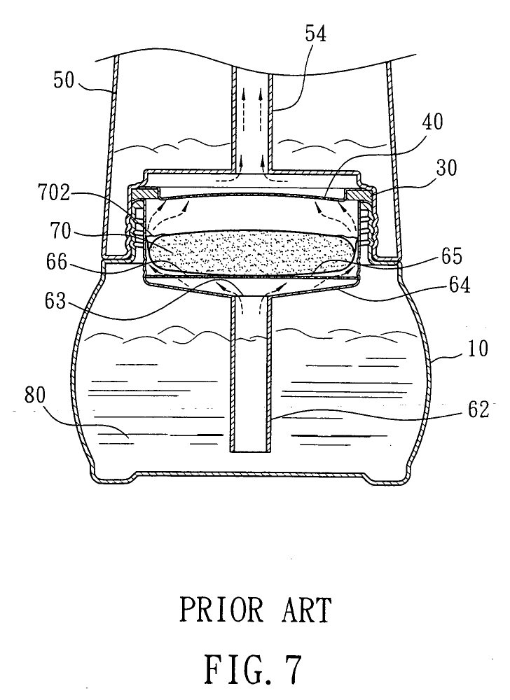

FIG. 8 is a prior art of coffee pack commonly sold in the market.

### DETAILED DESCRIPTION OF THE PREFERRED EMBODIMENTS

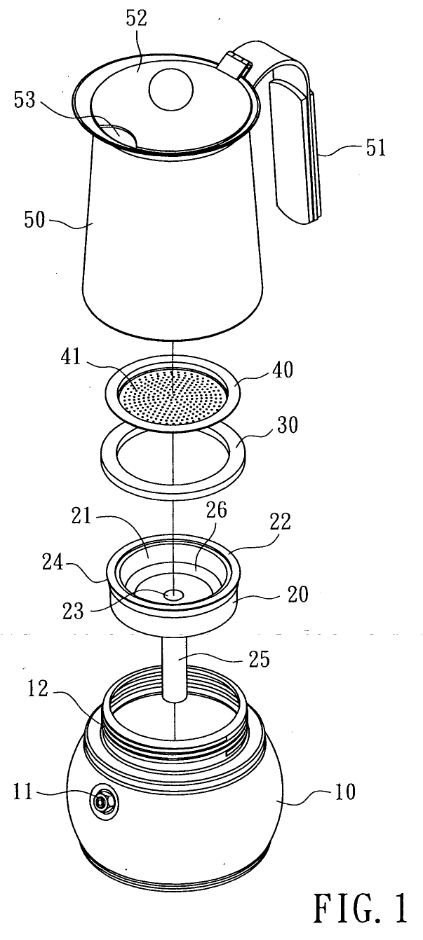

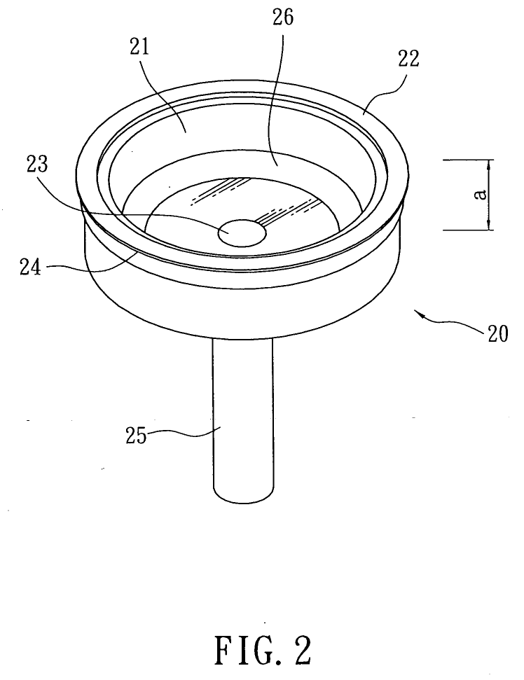

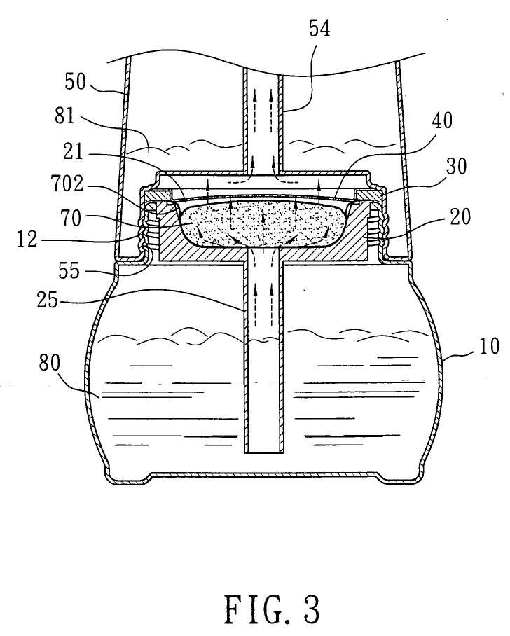

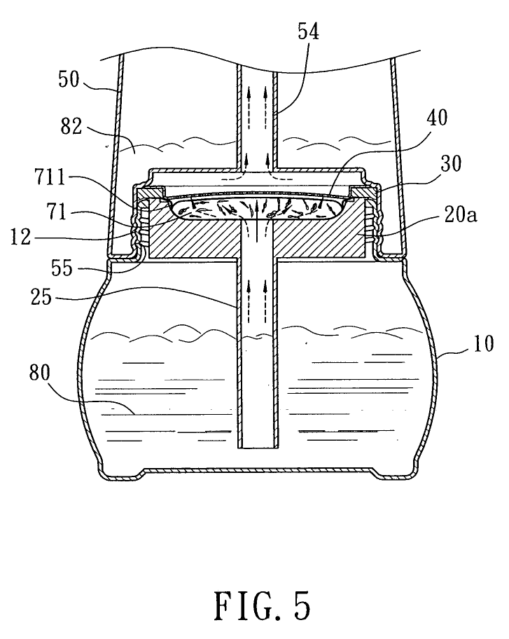

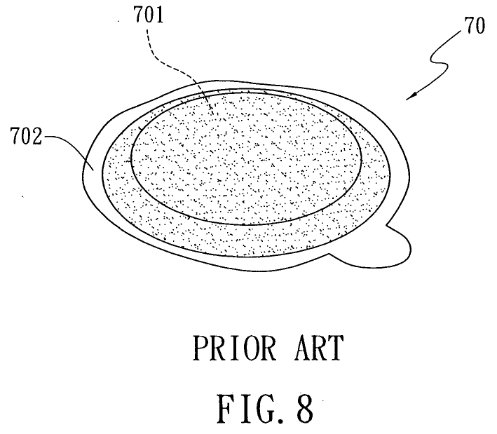

As shown in FIGS. 1 to 3, the invention relates to an improved structure of a mocha coffee maker, which is composed of a lower pot 10, a funnel 20, a rubber ring 30, a filter 40 and an upper pot 50. The lower pot 10 is provided at an upper position with a pressure relief valve 11, such that when the water contained in the lower pot 10 is boiling, the steam pressure can be released from the pressure relief valve 11. Besides, the top end of the lower pot 10 is provided with exterior threads 12. The top of the funnel 20 (as shown in FIG. 2) has a basin 21, the interior of which includes a circular inside wall and a top surface 22 and a hole 23 under the bottom. The interior diameter of the basin 21 conforms to the size of a standard coffee pack 70 (as shown in FIG. 8) or tea bag 71 (as shown in FIG. 5), while the basin 21 has a height a for measuring the thickness of the coffee pack 70. Meanwhile, the basin 21 has an expanded flange 24 at the outer rim, a hole 23 at the bottom, and a siphon 25 extending from the bottom hole 23 of the basin 21, such that when the funnel 20 is inserted into the lower pot 11, the flange 24 will be stopped at the top of the outer threads 12, whereas the siphon 25 stretches deep into the bottom of the lower pot 10 for releasing steam. An arc guide 26 is provided between the border where the circular interior wall and the flat bottom. When the lower pot 10 is screwed to the upper pot 50, the top surface 22 of the basin 21 would press on the outer film 702 of the coffee pack 70. The structure of the upper pot 50 includes a hollow portion for engaging with a filter 40 and a rubber ring 30. The filter 40 has pluralities of meshes 41 (as shown in FIG. 1). By way of the interior threads 55 at the bottom, the upper pot 50 can be fastened to the exterior threads 52 of the lower pot 10. The upper pot 50 is provided with a handle 51 and a lip 52 which has a spout 53 at a certain position of the edge. Besides, a conduit 54 is provided inside the upper pot 50 (as shown in FIG. 3). While the funnel is integrally formed via lathing, under the identical characteristics in structure, it can be separately formed via casting or pressing with metal sheet before combining with the siphon to accomplish the same effect.

Further referring to FIG. 3, when utilizing the invention for brewing a coffee pack 70, the user should directly dispose the coffee pack 70 in the basin 21 of the funnel 20 with the outer film 70 of the coffee pack 70 naturally spread on the top surface 22 of the lower pot 10; fill water 80 into the lower pot 10; and dispose the mocha coffee maker on fire for heating purpose. After the water 80 is boiled, the steam will rise along the only siphon 25 through the only hole 23 to the basin 21, thereby the condensed coffee 81 will be drawn to the upper pot 50 by way of the conduit 54 provided thereinside. In view of the funnel 20 structure, the coffee pack 70 can be conveniently brewed by the user himself/herself.

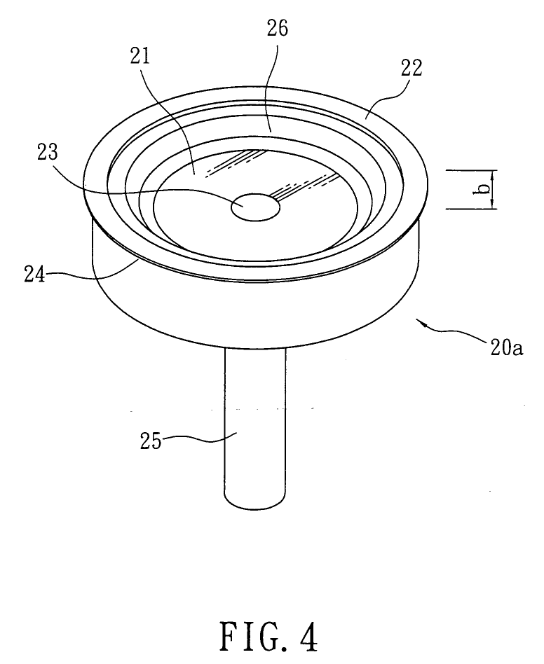

FIG. 4 is the perspective view of another funnel 20a according to the invention. As shown, the funnel 20a has a structure as that shown in FIG. 2, i.e., the bottom of the funnel 20a is likewise provided with a flat board, except that the height from the bottom board to the top surface 22 is altered to b, which is rather smaller, in order to be applicable to brewing a tea bag 71 (as shown in FIG. 5), since the average height of a tea bag 71 is smaller than that of a coffee pack 70. FIG. 5 shows an embodiment for brewing tea bag 71. As shown, by way the same theory and technique means, the comparatively thinner tea bag 71 is disposed in the basin 21 of the Type 2 funnel 20a, the outer film 711 of the tea bag 71 would naturally spread out and be pressed by the upper pot 50 and the lower pot 10, thereby obtaining tea beverage 82 of unique taste.

Concluded above, the improved structure of mocha coffee maker according to the invention is provided with a single steam outlet and a flat-bottomed basin of an appropriate size. The invention is applicable to brew a coffee pack or a tea bag of a standard size, thereby improving the convenience in coffee/tea making and simplifying the process of coffee/tea making. Besides, the invention is easily carried, thus is enriched of practicability to satisfy the consumers' needs. While certain novel features of this invention have been shown and described and are pointed out in the annexed Claims, it is not intended to be limited to the details above, since it will be understood that various omissions, modifications, substitutions and changes in the forms and details of the device illustrated and in its operation can be made by those skilled in the art without departing in any way from the spirit of the present invention.

1-6. (canceled)

7. A mocha coffee maker comprising:
a) a lower pot having a pressure relief valve and external threads;
b) a funnel inserted into an interior of the lower pot and having:
i) a basin having a flat bottom and an interior wall, the flat bottom having one hole in a center thereof, the basin having a size accommodating a brewing medium selected from a group consisting of a standard coffee pack and a tea bag, the brewing medium engaging the flat bottom of the basin;
ii) a siphon directly connected to the one hole of the flat bottom and extending downwardly into the lower pot; and
iii) an expanded flange located on a top thereof;
c) a filter having a plurality of meshes; and
d) an upper pot having:
i) internal threads connected to the exterior threads of the lower pot, an outer film of the brewing medium being located between the expanded flange of the funnel and the upper pot; and
ii) a conduit communicating with an interior of the upper pot and the basin,
wherein the basin has an arc guide formed between the interior wall and the flat bottom.

8. The mocha coffee maker according to claim 7, wherein the interior wall of the basin has a height between 5 mm and 8 mm.

9. The mocha coffee maker according to claim 7, wherein the upper pot includes a handle.

10. The mocha coffee maker according to claim 7, wherein the upper pot includes a lid with a spout.

11. The mocha coffee maker according to claim 7, further comprising a rubber ring located between the expanded flange of the funnel and the filter.

12. The mocha coffee maker according to claim 7, wherein the funnel and the siphon are integrally made.
